(19) United States
(12) Patent Application Publication
(10) Pub. No.: US 2026/0312102 A1
(43) Pub. Date: Oct. 8, 2026

(54) FUEL CELL SYSTEM AND CONTROL METHOD THEREFOR

(71) Applicant: Nissan Motor Co., Ltd., Yokohama-shi, Kanagawa (JP)

(72) Inventor: Shinji MIYAGAWA, Kanagawa (JP)

(21) Appl. No.: 19/476,265

(22) PCT Filed: Apr. 21, 2023
(86) PCT No.: PCT/JP2023/015988

§ 371 Date: Oct. 17, 2025

(51) Int. Cl. H01M 8/0662; H01M 8/04089; H01M 8/04223; H01M 8/04225; H01M 8/0432; H01M 8/04701; H01M 8/04746; H01M 8/0612; H01M 8/249

(52) U.S. Cl. CPC H01M 8/0662; H01M 8/04097; H01M 8/04225; H01M 8/04268; H01M 8/04373; H01M 8/04731; H01M 8/04776; H01M 8/0618; H01M 8/249

(57) ABSTRACT

The fuel cell system includes a reforming unit configured to reform a fuel gas containing a hydrocarbon to generate a reformed gas. The reforming unit contains a reforming catalyst, and a fuel cell stack configured to generate electricity by using the reformed gas as an anode gas. The control method includes a normal operation step of causing the fuel cell stack to generate electricity while supplying the fuel gas to the reforming unit, and a carbon removal step of removing carbon deposited on the reforming catalyst. The carbon removal step includes a step of supplying air to the reforming unit. A flow rate of the air to be supplied to the reforming unit in the carbon removal step is larger than a flow rate of the hydrocarbon to be supplied to the reforming unit in the normal operation step.

This application is a U.S. national stage application of International Application No. PCT/JP2023/015988, filed on Apr. 21, 2023.

### BACKGROUND

### Technical Field

The present invention relates to a fuel cell system and a control method therefor.

### Background Information

A fuel cell that generates electricity using hydrogen as a fuel is known. In such a fuel cell, a reforming catalyst may be used to generate hydrogen. In such a fuel cell, a fuel gas containing a hydrocarbon is reformed by a reforming catalyst, and a reformed gas containing hydrogen is generated. Then, electricity generation is performed using the generated reformed gas.

A technique relating to a fuel cell using a reforming catalyst is described in, for example, Japanese Publication No. 2005-340075A. Japanese Publication No. 2005-340075A describes a method of stopping an operation of a fuel cell having a specific reformer, in which while air is continuously supplied into the fuel cell, a specific mixed gas is supplied into the fuel cell through the reformer, when a temperature of the reforming catalyst falls within a specific temperature range, the supply of the mixed gas is stopped, and after the supply of the mixed gas is stopped, the air or a hydrocarbon gas is used as a purge gas and supplied to the fuel cell through the reformer.

### SUMMARY

When the reforming catalyst is continuously operated, carbon may be deposited to cover the reforming catalyst. When the reforming catalyst is covered with carbon, a reaction area decreases, and the reforming performance decreases. Thus, the deposited carbon is preferably removed.

Therefore, an object of the present invention is to provide a technique capable of removing carbon deposited on a reforming catalyst.

In one aspect, the present invention relates to a method for controlling a fuel cell system. The fuel cell system includes a reforming unit configured to reform a fuel gas containing a hydrocarbon to generate a reformed gas, the reforming unit containing a reforming catalyst, and a fuel cell stack configured to generate electricity by using the reformed gas as an anode gas. The control method includes a normal operation step of causing the fuel cell stack to generate electricity while supplying the fuel gas to the reforming unit, and a carbon removal step of removing carbon deposited on the reforming catalyst. The carbon removal step includes a step of supplying air to the reforming unit. A flow rate of the air to be supplied to the reforming unit in the carbon removal step is larger than a flow rate of the hydrocarbon to be supplied to the reforming unit in the normal operation step.

In another aspect, the present invention relates to a fuel cell system. The fuel cell system includes a reforming unit configured to reform a fuel gas containing a hydrocarbon to generate a reformed gas, the reforming unit containing a reforming catalyst, a fuel cell stack configured to generate electricity by using the reformed gas as an anode gas, and a control device. The control device executes a normal operation step and a carbon removal step. In the normal operation step, the control device causes the fuel cell stack to generate electricity while supplying the fuel gas to the reforming unit. In the carbon removal step, the control device supplies air to the reforming unit. A flow rate of the air to be supplied to the reforming unit in the carbon removal step is larger than a flow rate of the hydrocarbon to be supplied to the reforming unit in the normal operation step.

### BRIEF DESCRIPTION OF DRAWINGS

Referring now to the attached drawings which form a part of this original disclosure, illustrative embodiments are shown.

FIG. 1 is a schematic block diagram illustrating a fuel cell system according to a first embodiment.

FIG. 2 is a flowchart illustrating a method for controlling the fuel cell system according to the first embodiment.

FIG. 3 is a flowchart illustrating steps for activating a combustor.

FIG. 4 is a flowchart illustrating steps S20 and S30.

FIG. 5 is a flowchart illustrating a POX operation step (step S40).

FIG. 6 is a graph illustrating a modification of the first embodiment.

FIG. 7 is a graph illustrating another modification of the first embodiment.

FIG. 8 is a graph illustrating another modification of the first embodiment.

FIG. 9 is a schematic block diagram illustrating a fuel cell system according to a second embodiment.

FIG. 10 is a schematic block diagram illustrating a fuel cell according to a third embodiment.

FIG. 11 is a graph illustrating a relation between an operation time and a hydrogen generation amount in Experimental Example 1.

FIG. 12 is a graph illustrating a relation between an air flow rate and an outlet H₂ concentration.

### DESCRIPTION OF EMBODIMENTS

Hereinafter, embodiments of the present invention will be described with reference to the drawings.

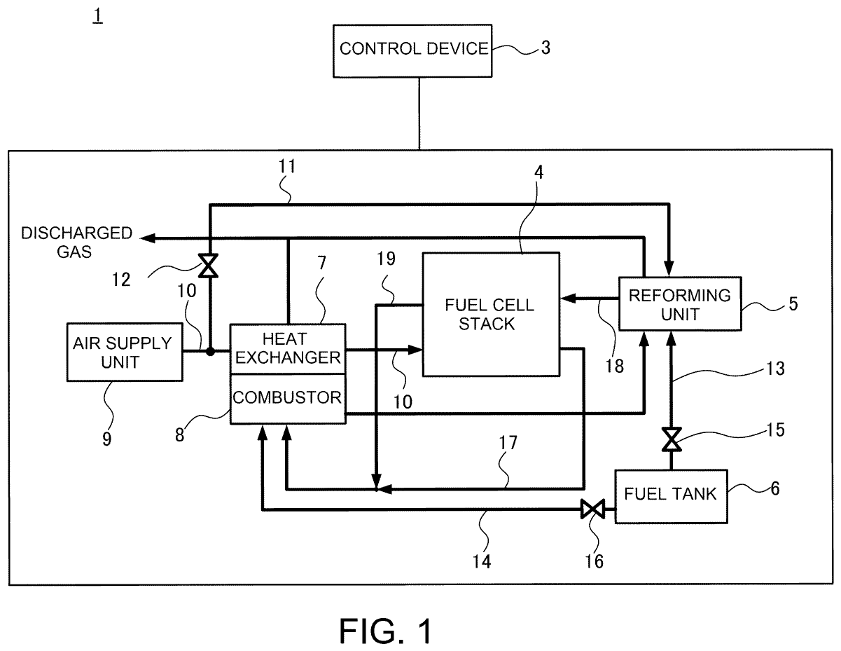

FIG. 1 is a schematic block diagram illustrating a fuel cell system 1 according to a first embodiment. As illustrated in FIG. 1, the fuel cell system 1 includes a control device 3, a fuel cell stack 4, a reforming unit 5, a fuel tank 6, a heat exchanger 7, a combustor 8, and an air supply unit 9. The fuel cell system 1 is steadily operated at a constant output (rated output) during a normal operation.

The fuel cell stack 4 is a portion that implements an electricity generation function. Although not illustrated, the fuel cell stack 4 includes an anode, an electrolyte, and a cathode. The fuel cell stack 4 generates electricity by receiving supply of an anode gas and a cathode gas. As the anode gas, a reformed gas to be supplied from the reforming unit 5 is used. As the cathode gas, air to be supplied from the air supply unit 9 is used.

The fuel cell stack 4 is connected to the combustor 8 via a line 19 on a downstream side of the anode. The fuel cell stack 4 is connected to the combustor 8 via a line 17 on a downstream side of the cathode. Accordingly, both a discharged gas from the anode and a discharged gas from the cathode are sent to the combustor 8.

The reforming unit 5 reforms a fuel gas to be supplied from the fuel tank 6 to generate a reformed gas containing hydrogen. The reforming unit 5 generates the reformed gas by moisture reforming. The moisture may be supplied from the fuel tank 6 together with the fuel gas, or may be supplied to the reforming unit 5 through a path (not illustrated) different from the fuel gas.

The reforming unit 5 contains a reforming catalyst. As the reforming catalyst, for example, Pt/CeO₂, Ni/CeO₂, or Rh/CeO₂ can be used.

The reforming unit 5 is connected to the anode of the fuel cell stack 4 via a line 18. The reformed gas generated by the reforming unit 5 is supplied to the anode of the fuel cell stack 4 via the line 18 as described above.

The fuel tank 6 stores the fuel gas. The fuel tank 6 is connected to the reforming unit 5 via a line 13. The line 13 is provided with a valve 15. The fuel tank 6 is also connected to the combustor 8 via a line 14. The line 14 is provided with a valve 16.

The fuel gas contains a hydrocarbon. The hydrocarbon is preferably methane. When methane is used, a methane-moisture reforming reaction can be executed in the reforming unit 5. Since methane is a non-alcohol fuel, the reforming catalyst in the reforming unit 5 is less likely to deteriorate due to its acidic site.

The air supply unit 9 is provided to supply air as the cathode gas to the fuel cell stack 4. The air supply unit 9 is implemented by, for example, a blower. The air supply unit 9 is connected to the cathode of the fuel cell stack 4 via an air supply line 10.

The air supply unit 9 may also send air to the reforming unit 5. Specifically, the air supply line 10 is connected to the reforming unit 5 via a purge line 11. The purge line 11 is provided with a valve 12. By operating the valve 12, air may be supplied from the air supply unit 9 to the reforming unit 5.

The heat exchanger 7 is provided in the air supply line 10. The heat exchanger 7 is thermally connected to the combustor 8. Accordingly, the air flowing through the air supply line 10 is heated by the heat from the combustor 8.

The heat exchanger 7 is provided downstream of a connection portion between the purge line 11 and the air supply line 10. Therefore, the air sent from the air supply unit 9 to the reforming unit 5 via the purge line 11 is not heated by the heat exchanger 7.

As described above, the combustor 8 is provided to heat the air via the heat exchanger 7. The fuel gas from the fuel tank 6, the discharged gas from the cathode of the fuel cell stack 4, and the discharged gas from the anode of the fuel cell stack 4 are supplied to the combustor 8. In the combustor 8, these gases are combusted. The combustion gas generated in the combustor 8 is discharged to the outside as discharged gas.

The combustor 8 is also connected to the reforming unit 5 such that the combustion gas exchanges heat with the reforming unit 5 and then is discharged as a discharged gas.

The control device 3 is provided to control an overall operation of the fuel cell system 1. The control device 3 is implemented by, for example, a computer including an arithmetic device such as a CPU and a storage device such as a RAM and a ROM. That is, the control device 3 implements its function by the arithmetic device executing a control program stored in the storage device.

The above is the schematic configuration of the fuel cell system 1. Next, a method of operating the fuel cell system 1 will be described.

First, the operation of the fuel cell system 1 during the normal operation will be described. During the normal operation, the fuel cell system 1 is operated at a predetermined constant output (rated output).

Specifically, the valve 12 is closed and the valves 15 and 16 are opened by the control device 3. Accordingly, the fuel gas is supplied from the fuel tank 6 to the reforming unit 5 and the combustor 8. In order to obtain a constant output, the fuel gas is supplied to the reforming unit 5 at a constant flow rate. In the reforming unit 5, the fuel gas is reformed by moisture reforming to generate a reformed gas. The generated reformed gas is sent to the anode of the fuel cell stack 4 via the line 18. The reformed gas supplied to the anode is used for electricity generation, and then is sent to the combustor 8 via the line 19 as an anode discharged gas.

The air is supplied from the air supply unit 9 to the cathode of the fuel cell stack 4 via the air supply line 10 and the heat exchanger 7. In order to obtain a constant output, the air is sent to the cathode at a constant flow rate. The air supplied to the cathode is used for electricity generation and then sent to the combustor 8 via the line 17 as a cathode discharged gas.

In the combustor 8, the gas sent from the line 14, the line 17, and the line 19 is combusted. Accordingly, the air is heated via the heat exchanger 7. That is, heated air is supplied to the fuel cell stack 4. A fuel cell usually exhibits its function in a high-temperature state. By supplying the heated air, a temperature required for electricity generation in the fuel cell stack 4 is maintained. The combustion gas generated in the combustor 8 is discharged as a discharged gas. In addition, a part of the combustion gas is discharged after exchanging heat with the reforming unit 5. Accordingly, the temperature of the reforming unit 5 is also maintained at a temperature necessary for the reforming reaction.

The above is the operations during the normal operation.

Here, as a result of the operation, carbon may be deposited on the reforming catalyst in the reforming unit 5. The reason is considered to be a disproportionation reaction of CO (2CO→C+CO₂) as a by-product of the reforming reaction. When a surface of the reforming catalyst is coated with carbon, the efficiency of the reforming reaction decreases.

Therefore, in the present embodiment, the carbon removal step is executed to remove the deposited carbon. In the carbon removal step, the air is supplied to the reforming unit 5. Specifically, the valve 12 (see FIG. 1) is opened by the control device 3, and the air is supplied to the reforming unit 5 via the purge line 11. The valve 15 is closed. That is, the fuel gas is not supplied to the reforming unit 5.

The air to be supplied to the reforming unit 5 in the carbon removal step has a large flow rate. Specifically, the air is supplied to the reforming unit 5 at a flow rate equal to or higher than the flow rate of the hydrocarbon to be supplied to the reforming unit 5 during the normal operation. By supplying such an amount of air to the reforming unit 5, carbon deposited on the reforming catalyst can be removed, and the function of the reforming catalyst can be restored. The “flow rate of hydrocarbon to be supplied to the reforming unit during the normal operation” here is not the flow rate of the entire fuel gas, but is merely the flow rate of hydrocarbon. For example, when the hydrocarbon contained in the fuel gas is methane, the flow rate of methane is the “flow rate of the hydrocarbon to be supplied to the reforming unit 5”.

Preferably, the flow rate of the air to be supplied to the reforming unit 5 in the carbon removal step is four times or more the flow rate of the hydrocarbon to be supplied to the reforming unit 5 during the normal operation. When the air is supplied at such a flow rate, the carbon can be more reliably removed.

Alternatively, based on the number of moles, a molar flow rate based on oxygen (O₂) of the air to be supplied to the reforming unit 5 in the carbon removal step is preferably 0.84 or more with respect to a molar flow rate based on carbon (C) of the fuel gas to be supplied to the reforming unit 5 during the normal operation. When the air is supplied at such a flow rate, the carbon can be more reliably removed.

The above is the schematic configuration and operation of the present embodiment. As described above, according to the present embodiment, deposited carbon can be removed by supplying air to the reforming unit 5 at a large flow rate. Accordingly, the reforming function can be restored.

A timing of executing the carbon removal step is not particularly limited. However, when the carbon removal step is executed at the time of activating the fuel cell system 1, the removal of carbon and the activation of the fuel cell system 1 can be executed simultaneously, which is efficient. Hereinafter, a method for controlling the fuel cell system 1 according to the present embodiment will be specifically described by taking, as an example, a case where the carbon removal step is executed at the time of activating the fuel cell system 1. Unless otherwise specified, the following control method is executed by the control device 3.

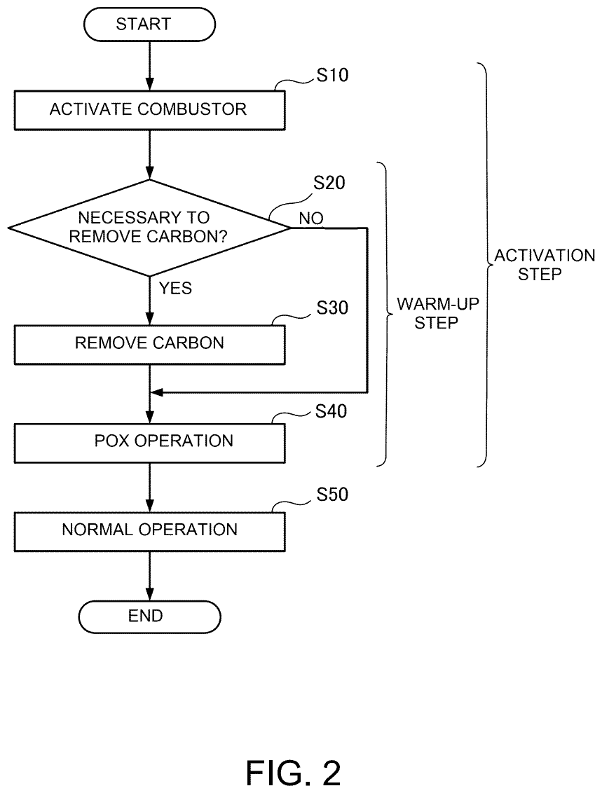

FIG. 2 is a flowchart illustrating the method for controlling the fuel cell system 1 according to the present embodiment. The method for controlling the fuel cell system schematically includes an activation step (S10 to S40) and a normal operation step (S50). The activation step (S10 to S40) includes a step of activating the combustor 8 (S10), a step of determining whether it is necessary to remove carbon (S20), a carbon removal step (S30), and a step of executing a POX operation (S40). After the activation step (S10) of the combustor 8, heated air is supplied to the cathode of the fuel cell stack 4 via the air supply line 10. Therefore, the fuel cell stack 4 is heated. That is, the fuel cell stack 4 is warmed up. Therefore, it can be said that steps S20 to S40 executed after the activation of the combustor 8 (after step S10) are executed in the warm-up step of the fuel cell stack 4.

Hereinafter, each step will be described in detail.

### Step S10: Activation of Combustor

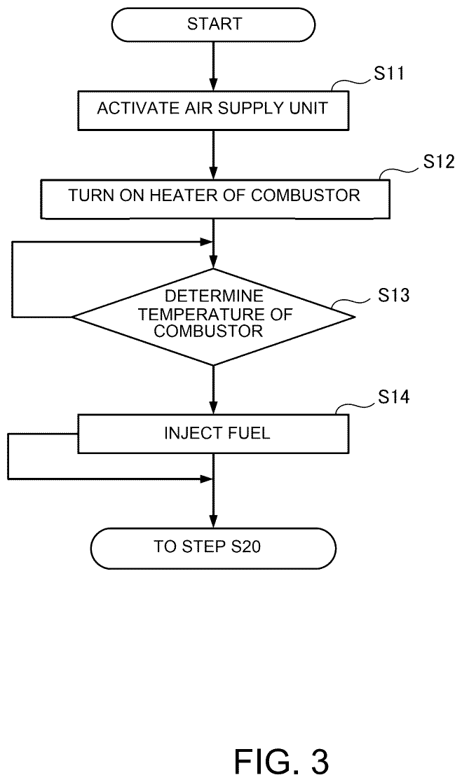

First, the combustor 8 is activated. FIG. 3 is a flowchart illustrating steps of activating the combustor 8.

First, the air supply unit 9 is activated (step S11). Accordingly, air flows from the air supply unit 9 to the heat exchanger 7, the cathode of the fuel cell stack 4, and the combustor 8 via the air supply line 10 in this order. The valve 12 is closed. That is, air is not supplied to the reforming unit 5.

Further, a heater (not illustrated) of the combustor 8 is operated (step S12).

Subsequently, it is determined whether a temperature of the combustor 8 is equal to or higher than a predetermined temperature (step S13). Specifically, the control device 3 measures the temperature of the combustor 8 by a temperature sensor or the like (not illustrated). Then, the control device 3 compares a measurement result with a predetermined temperature stored in advance. Here, the predetermined temperature is a temperature set in view of whether the combustion reaction is possible in the combustor 8. For example, when the combustor 8 contains a combustion catalyst, a light-off temperature (for example, 350° C.) of the combustion catalyst is set as the predetermined temperature.

When the temperature of the combustor 8 is equal to or higher than the predetermined temperature, the fuel gas is injected into the combustor 8 (step S14). That is, the valve 16 is opened, and the fuel gas is supplied from the fuel tank 6 to the combustor 8 via the line 14. Accordingly, the combustion reaction proceeds in the combustor 8, and the combustor 8 is activated.

As described above, after the activation of the combustor 8, heated air is supplied to the cathode of the fuel cell stack 4 via the heat exchanger 7. That is, as described above, the fuel cell stack 4 is warmed up. The reforming unit 5 is also heated by the heat of the combustion gas sent from the combustor 8.

### Step S20: Determination on Necessity of Carbon Removal

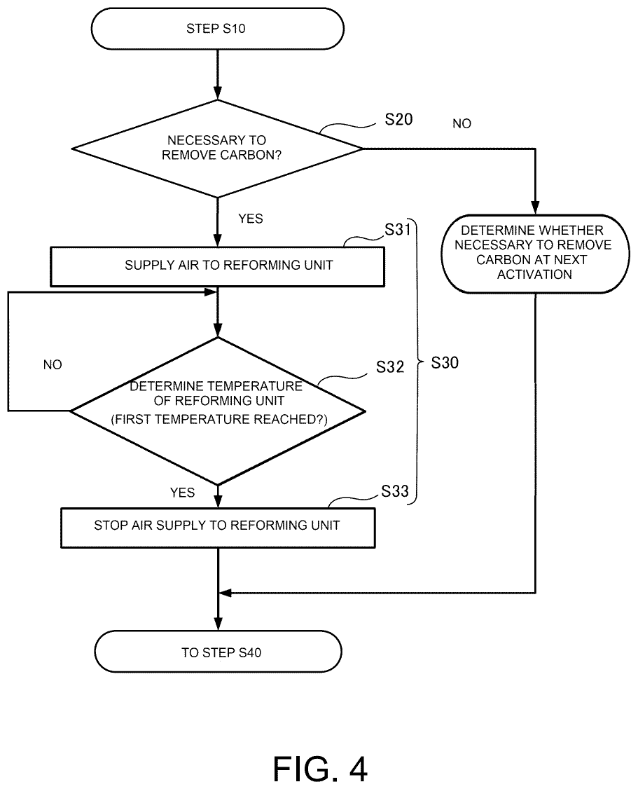

FIG. 4 is a flowchart illustrating step S20 and the next carbon removal step S30. After the activation of the combustor 8, first, it is determined whether the carbon removal step is necessary (step S20).

The necessity of the carbon removal step is determined by, for example, an accumulated operation time. For example, the control device 3 stores, as data, the accumulated operation time since the previous execution of the carbon removal step. The control device 3 compares the accumulated operation time with a predetermined time set in advance. When the accumulated operation time exceeds the predetermined time, it is determined that the carbon removal step is necessary.

Alternatively, the necessity of the carbon removal step may be determined based on the reforming performance at the time of the previous operation. The reforming performance can also be determined based on, for example, an outlet temperature of the reforming unit 5. The reforming reaction in the reforming unit 5 is an endothermic reaction. Therefore, when the reforming function decreases, the outlet temperature of the reforming unit 5 increases. That is, it can be said that the outlet temperature of the reforming unit 5 reflects the reforming performance of the reforming unit 5. Therefore, it is also possible to determine whether the carbon removal step is necessary based on the outlet temperature of the reforming unit 5 at the time of the previous operation. For example, the control device can compare the outlet temperature of the reforming unit 5 at the time of the previous operation with the outlet temperature of the reforming unit 5 in a preset initial state, and determine whether the carbon removal step is necessary when a difference of the outlet temperatures is a predetermined value (for example, 10% of value in initial state) or more.

As a result of the determination, when the carbon removal step is unnecessary, it is determined whether the carbon removal step is necessary at the next activation, and the processing of step S40 and the subsequent steps is executed. Accordingly, the carbon removal step is not unnecessarily executed, and the energy efficiency can be improved.

On the other hand, when it is determined that the carbon removal step is necessary, the next carbon removal step S30 is executed.

### Step S30: Carbon Removal Step

In the carbon removal step, the valve 12 (see FIG. 1) is opened (step S31), as described above. Accordingly, the air is supplied from the air supply unit 9 to the reforming unit 5 via the purge line 11. As described above, at this time, the air is supplied to the reforming unit 5 at a predetermined large flow rate.

By supplying the air, the carbon deposited from the reforming unit 5 is removed. The removed carbon is sent to the combustor 8 via the anode of the fuel cell stack 4 and the line 19. Then, the removed carbon is combusted in the combustor 8, detoxified, and then discharged to the outside.

The air is supplied from the air supply unit 9 to the reforming unit 5 without being heated. When the air is supplied to the reforming unit 5 in a high-temperature state, the reforming catalyst may be oxidized and deteriorated. However, according to the present embodiment, since the air is supplied without being heated, it is possible to suppress oxidation degradation of the reforming catalyst. In addition, oxidation degradation of an electrode material is also similarly suppressed in the anode of the fuel cell stack 4 located downstream of the reforming unit 5.

Even during the supply of air, the temperature of the reforming unit 5 increases because the reforming unit 5 is heated by the heat from the combustor 8. Therefore, the carbon removal step is executed until the temperature of the reforming unit 5 reaches a predetermined temperature. Specifically, the control device 3 determines whether the temperature of the reforming unit 5 reaches a preset first temperature during the supply of air (step S32). For example, the control device 3 measures the temperature of the reforming unit 5 using a sensor (not illustrated). The temperature of the reforming unit 5 may be indirectly obtained by measuring the outlet temperature of the reforming unit 5.

When it is determined in step S32 that the temperature of the reforming unit 5 reaches the first temperature, the control device 3 closes the valve 12. Accordingly, the supply of air to the reforming unit 5 is stopped (step S33). That is, the carbon removal step ends.

The above-described first temperature is set from the viewpoint of deterioration of the substance contained in the reforming unit 5. When the air is supplied to the reforming unit 5 in a state where the temperature of the reforming unit 5 is high, the reforming catalyst may deteriorate due to sintering or oxidation. Further, even in the fuel cell stack 4 downstream of the reforming unit 5, the anode is easily oxidized and deteriorated. In contrast, the supply of air is stopped when the temperature reaches the first temperature, so that it is possible to prevent the oxidation degradation of the reforming catalyst and the anode. The first temperature is, for example, 300° C.

The carbon removal step is preferably executed for, for example, 15 seconds or longer, preferably 30 seconds or longer, and more preferably 1 minute or longer.

### Step S40: POX Operation

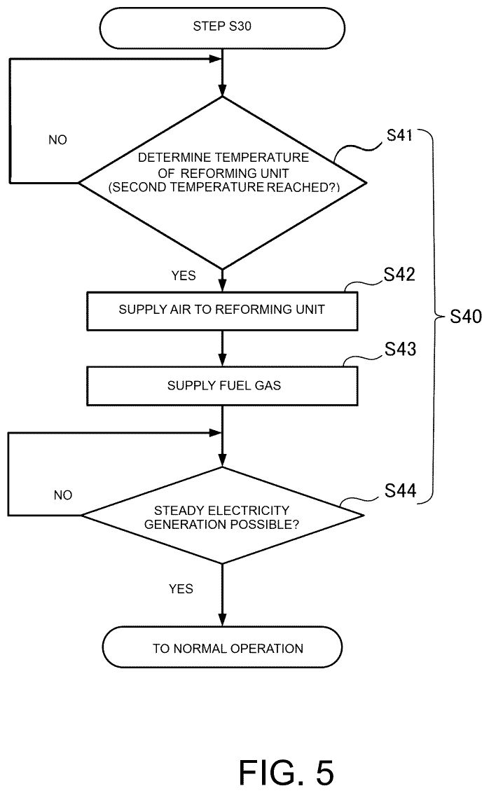

After completion of the carbon removal step (S30), the POX operation step (S40) is executed. FIG. 5 is a flowchart illustrating the POX operation step (step S40). The POX operation is executed to promote the warm-up of the fuel cell stack 4.

Specifically, the reforming unit 5 is heated by the combustion gas from the combustor 8 even after the completion of the carbon removal step. Therefore, in step S41, the control device 3 determines whether the temperature of the reforming unit 5 is equal to or higher than a preset second temperature. The second temperature is a temperature determined based on whether a POX reaction (partial oxidation reaction: CH₄+1/2O₂→CO+2H₂) proceeds, and is a temperature higher than the first temperature, for example, 400° C.

When it is determined in step S41 that the temperature of the reforming unit 5 reaches the second temperature, the valve 12 is opened, and the air is supplied to the reforming unit 5 via the purge line 11 (see FIG. 1) (step S42). In addition, the valve 15 (see FIG. 1) is opened, and the fuel gas is supplied from the fuel tank 6 to the reforming unit 5 (step S43). Accordingly, the POX reaction proceeds in the reforming unit 5. The amount of the air to be supplied to the reforming unit 5 in step S42 may be an amount that allows the POX reaction to proceed, and the amount is sufficiently smaller than the amount in the carbon removal step (S30).

Thereafter, it is determined whether steady electricity generation is possible (for example, whether temperature of reforming unit 5 reaches desired temperature) (step S44), and when it is determined that steady electricity generation is possible, the normal operation is executed. During the normal operation, as described above, the valve 12 is closed, and the air is not supplied to the reforming unit 5.

The first embodiment has been described above. As described above, according to the present embodiment, in the carbon removal step (S30), since the air is supplied to the reforming unit 5 at a large flow rate, the carbon deposited on the reforming catalyst can be removed, and the reforming performance can be restored.

Since the carbon removal step (S30) is executed in the activation step, the activation of the fuel cell system 1 and the removal of carbon can be executed simultaneously. Accordingly, the carbon can be efficiently removed.

In the present embodiment, the carbon removal step (S30) is executed after the activation of the combustor 8. Therefore, the carbon removed from the reforming unit 5 can be combusted in the combustor 8. Accordingly, the removed carbon can be detoxified and then discharged to the outside.

In the carbon removal step (S30), the amount of the air to be supplied to the reforming unit 5 may be constant, but may not be constant. Hereinafter, the supply amount of the air will be described with reference to modifications.

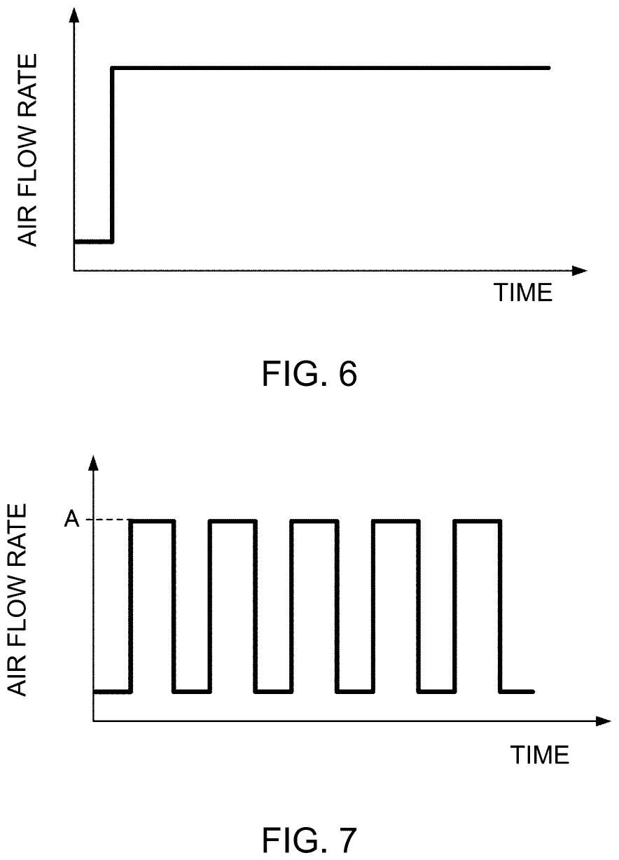

FIG. 6 is a graph illustrating a modification of the present embodiment, and is a graph illustrating a relation between a time and the flow rate of the air to be supplied to the reforming unit 5 in the carbon removal step (S30). In this example, after the carbon removal step (S30) is started, the air is supplied at a constant flow rate. As in this modification, for example, the air can be supplied to the reforming unit 5 at a constant flow rate.

On the other hand, FIG. 7 is a graph illustrating another modification, and is a graph illustrating a relation between a time and the flow rate of the air to be supplied to the reforming unit 5 in the carbon removal step (S30). In this example, the air is intermittently supplied. Further, the flow rate at the time of air supply (see “A” in the drawing) is larger than the flow rate of the hydrocarbon during the normal operation.

According to the modification illustrated in FIG. 7, it is possible to reduce a contact time between the reforming catalyst and the air by intermittently supplying the air. Therefore, oxidation degradation of the reforming catalyst can be prevented. For the same reason, the oxidation degradation of the anode electrode can also be suppressed in the fuel cell stack 4 located downstream of the reforming unit 5.

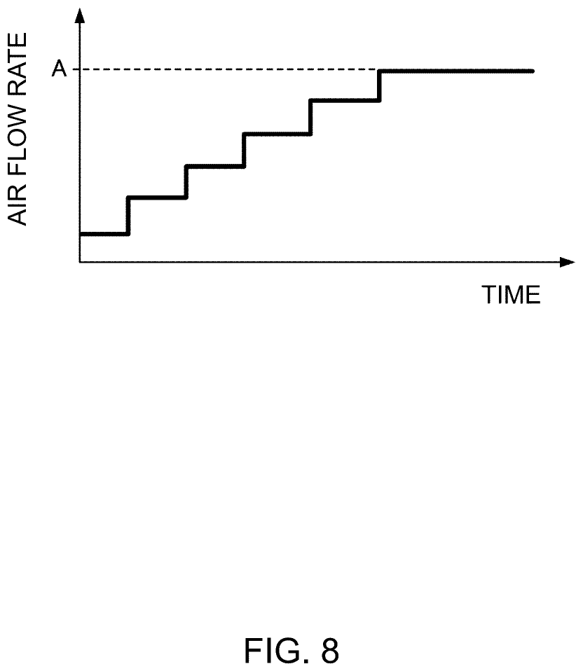

FIG. 8 is a graph illustrating another modification, and is a graph illustrating a relation between a time and the flow rate of the air to be supplied to the reforming unit 5 in the carbon removal step (S30). In this example, the supply amount of the air is increased stepwise. Further, the final flow rate of the air (see “A” in drawing) is larger than the flow rate of the hydrocarbon during the normal operation.

According to the modification illustrated in FIG. 8, since the flow rate of the air increases stepwise, the entire surface of the reforming catalyst is easily treated with the air. Accordingly, the carbon can be more efficiently removed.

Use of the fuel cell system 1 according to the present embodiment is not particularly limited, but is, for example, for in-vehicle use. The in-vehicle fuel cell system 1 is required to be downsized. As a result, it is used under severe conditions (for example, high SV and low S/C). Therefore, the carbon is easily deposited on the reforming catalyst. The present embodiment can solve such a problem relating to carbon deposition, and thus is particularly useful in an in-vehicle fuel cell system.

In the present embodiment, an S/C ratio (molar ratio of moisture to carbon) during the normal operation is, for example, 5 or less, preferably 1 to 5, and more preferably 1 to 3. In a fuel cell used at such a low S/C ratio, the carbon is likely to be deposited on the reforming catalyst, as described above. The present embodiment can solve the problem relating to carbon deposition, and thus is particularly valuable in a fuel cell operated at such an S/C ratio.

In the present embodiment, a space velocity GHSV of the gas to be supplied to the reforming unit 5 during the normal operation is, for example, 30,000 ⁻¹ or more, and preferably 40,000 h⁻¹ to 100,000 h⁻¹. The fuel cell used at such GHSV can be said to be a fuel cell used under severe conditions, and as described above, the carbon is likely to be deposited on the reforming catalyst. The present embodiment can solve the problem relating to carbon deposition, and thus is particularly valuable in a fuel cell system used in such GHSV.

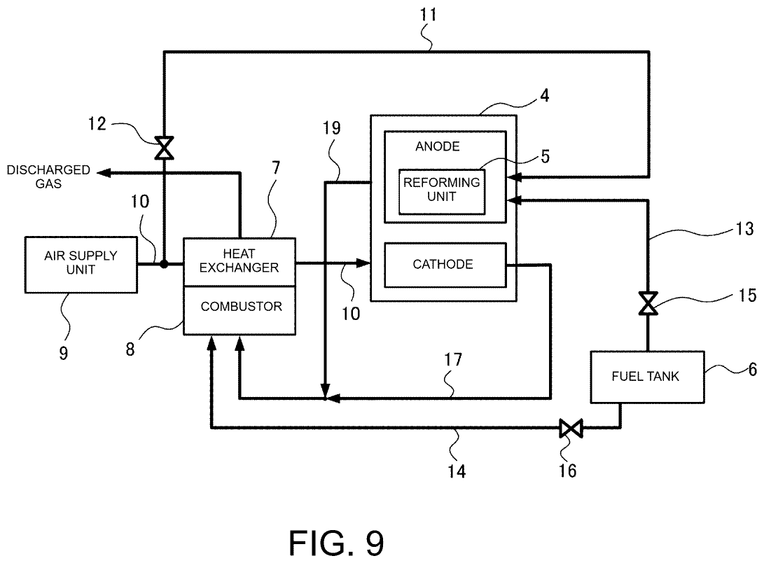

Next, a second embodiment will be described. FIG. 9 is a schematic block diagram illustrating the fuel cell system 1 according to a second embodiment. A detailed description of a point that the same configuration as that of the first embodiment can be adopted will be omitted.

As illustrated in FIG. 9, in the present embodiment, the reforming unit 5 is provided at an anode of the fuel cell stack 4. That is, the anode of the fuel cell stack 4 contains a reforming catalyst. Accordingly, the purge line 11 is connected to the anode of the fuel cell stack 4. The line 13 for supplying a fuel gas is also connected to the anode of the fuel cell stack 4.

A method for controlling the fuel cell system according to the present embodiment is basically the same as that in the first embodiment. However, in the present embodiment, a combustor inlet temperature reflects a reforming performance of the reforming unit 5. Therefore, in step S20 (see FIG. 4), it is possible to determine whether a carbon removal step is necessary based on the combustor inlet temperature during the previous operation. In addition, a temperature of the reforming unit 5 is reflected in an outlet temperature of the anode. Therefore, in step S32 (see FIG. 4) and step S41 (see FIG. 5), it may be determined whether a temperature of the reforming unit 5 reaches a predetermined temperature based on an outlet temperature of the anode.

In the present embodiment, the carbon removal step is also executed as in the first embodiment, so that the deposited carbon can be removed, and the reforming performance can be restored. Further, according to the present embodiment, since the reforming catalyst is disposed inside the fuel cell stack 4, the volume of the fuel cell system can be reduced. Accordingly, improvement in electricity generation efficiency can be expected. In addition, a reduction in cost due to a reduction in the number of components can be expected.

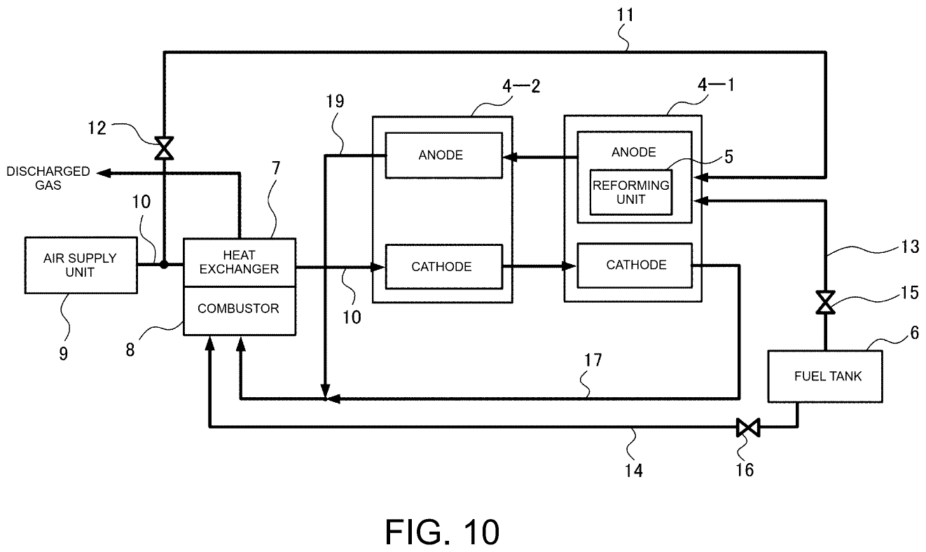

Next, a third embodiment will be described. FIG. 10 is a schematic block diagram illustrating a fuel cell system according to a third embodiment. A detailed description of a point that the same configuration as that of the above-described embodiments can be adopted will be omitted.

In the present embodiment, the fuel cell stack 4 includes a first stack 4-1 and a second stack 4-2. Each stack (4-1, 4-2) has an anode, an electrolyte layer (not illustrated), and a cathode.

The reforming unit 5 is disposed at the anode of the first stack 4-1. Accordingly, the purge line 11 is connected to the anode of the first stack 4-1. The line 13 for supplying a fuel gas is also connected to the anode of the first stack 4-1. The anode of the first stack 4-1 is connected to the anode of the second stack 4-2 on the downstream side thereof. That is, the first stack 4-1 and the second stack 4-2 are connected to each other such that the gas flows from the anode of the first stack 4-1 toward the anode of the second stack 4-2. The anode of the second stack 4-2 is connected to the combustor 8 via the line 19 on the downstream side thereof.

On the other hand, the air supply line 10 is connected to the cathode of the second stack 4-2. The cathode of the second stack 4-2 is connected to the cathode of the first stack 4-1 on the downstream side thereof. That is, the first stack 4-1 and the second stack 4-2 are connected to each other such that the gas flows from the cathode of the second stack 4-2 to the cathode of the first stack 4-1. The cathode of the first stack 4-1 is connected to the combustor 8 via the line 17 on the downstream side thereof.

A method for controlling the fuel cell system according to the present embodiment is the same as that of the previously described embodiments. That is, as illustrated in FIG. 2, first, the combustor 8 is activated (step S10). Thereafter, a carbon removal step (S30) is executed during warm-up of the fuel cell stack 4.

Here, in the present embodiment, during the warm-up of the fuel cell stack 4 (steps S20 to S40), heated air flows from the cathode of the second stack 4-2 to the cathode of the first stack 4-1 in this order. Therefore, the second stack 4-2 is heated earlier than the first stack 4-1. In other words, during the warm-up, a temperature of the first stack 4-1 is less likely to rise than that of the second stack 4-2.

On the other hand, in the carbon removal step (S30), air is supplied from the purge line 11 to the reforming unit 5 provided in the first stack 4-1. That is, the air is supplied to the reforming unit 5 in the first stack 4-1 having a relatively low temperature. Since the air is not supplied to the reforming catalyst in the high-temperature state, the oxidative degradation of the reforming catalyst can be suppressed more reliably.

Although the embodiments of the present invention have been described above, the above embodiments merely show a part of the application example of the present invention, and the technical scope of the present invention is not limited to the specific configuration of the above embodiments.

Hereinafter, a representative relation between the configuration and the operation and effect of the embodiments of the present invention will be summarized.

In one aspect, the present embodiment relates to a method for controlling the fuel cell system 1. The fuel cell system 1 includes the reforming unit 5 configured to reform a fuel gas containing a hydrocarbon to generate a reformed gas, the reforming unit 5 containing a reforming catalyst, and the fuel cell stack 4 configured to generate electricity by using the reformed gas as an anode gas. The control method includes a normal operation step (S50) of causing the fuel cell stack 4 to generate electricity while supplying the fuel gas to the reforming unit 5, and a carbon removal step (S30) of removing carbon deposited on the reforming catalyst. The carbon removal step (S30) includes a step of supplying air to the reforming unit 5. A flow rate of the air to be supplied to the reforming unit 5 in the carbon removal step (S30) is larger than a flow rate of the hydrocarbon to be supplied to the reforming unit 5 in the normal operation step (S50). According to such a method, deposited carbon can be removed by supplying air to the reforming unit 5 at a specific flow rate.

Preferably, the flow rate of the air to be supplied to the reforming unit 5 in the carbon removal step (S30) is four times or more the flow rate of the hydrocarbon to be supplied to the reforming unit 5 during the normal operation step (S50). According to such a method, the deposited carbon may be more reliably removed.

Preferably, the fuel gas contains methane. According to such a method, a methane-moisture reforming reaction can be executed in the reforming unit 5. Since methane is a non-alcohol fuel, the reforming catalyst in the reforming unit 5 is less likely to deteriorate due to its acidic site.

In one preferred aspect, the control method includes a step (S20) of determining whether to execute the carbon removal step based on an execution time of the normal operation step. Accordingly, the carbon removal step is not unnecessarily executed, and the energy efficiency can be improved.

In one preferred aspect, the control method includes a step (S20) of determining whether to execute the carbon removal step based on an outlet temperature of the reforming unit. Accordingly, the carbon removal step is not unnecessarily executed, and the energy efficiency can be improved.

In one preferred aspect, the control method includes an activation step of activating the fuel cell stack 4 before the normal operation step (S50). The carbon removal step (S30) is executed in the activation step. According to this method, since activation of the fuel cell stack and removal of the carbon can be executed simultaneously, the fuel cell system 1 can be operated efficiently.

In one preferred aspect, the fuel cell system 1 further includes the air supply line 10 that supplies air to a cathode of the fuel cell stack 4, and a combustor 8 that is thermally connected to the air supply line 10 and heats the air. The activation step includes a combustor activation step of activating the combustor to a predetermined temperature or higher. The carbon removal step (S30) is executed after the combustor activation step. The carbon removal step (S30) includes a step of sending the removed carbon to the combustor 8. According to this method, the carbon removed in the carbon removal step can be combusted by the combustor 8. Accordingly, carbon may be detoxified and then discharged to the outside.

In one preferred aspect, the fuel cell stack 4 includes the first stack 4-1 and the second stack 4-2. The reforming unit 5 is disposed at an anode of the first stack 4-1. The air supply line 10 is connected to a cathode of the second stack 4-2. The first stack 4-1 and the second stack 4-2 are connected to each other such that a gas flows from the anode of the first stack 4-1 to an anode of the second stack 4-2, and a gas flows from the cathode of the second stack 4-2 to a cathode of the first stack 4-1. The activation step includes a warm-up step of heating the fuel cell stack 4 by supplying the air to the cathode of the second stack 4-2 via the air supply line 10 after the combustor activation step. The carbon removal step (S30) is executed during the warm-up step. According to this method, in the carbon removal step, the air is supplied to the reforming unit 5 of the first stack 4-1 having a relatively low temperature. Since it is possible to prevent the reforming catalyst from being treated with oxygen in a high-temperature state, it is possible to suppress oxidation degradation of the reforming catalyst.

In one preferred aspect, the carbon removal step (S30) includes a step of stopping the supply of the air to the reforming unit 5 when a temperature of the reforming unit reaches a first temperature. According to this method, air is prevented from being supplied to the reforming unit 5 in a high-temperature state. Accordingly, the oxidation degradation of the reforming catalyst can be suppressed.

In one preferred aspect, the carbon removal step (S30) includes a step of supplying the air from the air supply unit 9 to the reforming unit 5 without heating. According to this method, the reforming catalyst is prevented from being treated with high-temperature oxygen. Accordingly, the oxidation degradation of the reforming catalyst can be suppressed.

In one preferred aspect, the carbon removal step (S30) includes a step of intermittently supplying the air to the reforming unit 5. According to this method, a contact time between the reforming catalyst and oxygen can be reduced. As a result, oxidation degradation of the reforming catalyst can be suppressed.

In one preferred aspect, the carbon removal step (S30) includes a step of supplying the air to the reforming unit 5 such that a flow rate of the air increases stepwise. According to this method, the entire surface of the reforming catalyst is treated with the air, and the carbon can be more efficiently removed.

In one preferred aspect, the reforming unit 5 is disposed in the fuel cell stack 4. According to this method, since the reforming catalyst is disposed inside the fuel cell stack 4, a volume of the fuel cell system can be reduced. Accordingly, improvement in electricity generation efficiency can be expected. In addition, a reduction in cost due to a reduction in the number of components can be expected.

In one aspect, the fuel cell system 1 includes the reforming unit 5 configured to reform a fuel gas containing a hydrocarbon to generate a reformed gas, the reforming unit 5 containing a reforming catalyst, the fuel cell stack 4 configured to generate electricity by using the reformed gas as an anode gas, and the control device 3. The control device 3 executes a normal operation step and a carbon removal step. In the normal operation step, the control device 3 causes the fuel cell stack to generate electricity while supplying the fuel gas to the reforming unit 5. In the carbon removal step, the control device supplies air to the reforming unit 5. A flow rate of the air to be supplied to the reforming unit 5 in the carbon removal step is larger than a flow rate of the hydrocarbon to be supplied to the reforming unit 5 in the normal operation step. According to the fuel cell system 1, deposited carbon can be removed by supplying the air to the reforming unit 5 at a specific large flow rate.

### EXAMPLES

Hereinafter, in order to describe the present invention in more detail, examples carried out by the present inventors will be described. However, the present invention should not be construed as being limited to the following examples.

### Experimental Example 1

A normal operation was executed for 350 hours using the fuel cell system 1 described in the third embodiment (see FIG. 10). An S/C ratio was 2. As a fuel gas, a mixed gas containing methane, moisture, and N₂ was used. GHSV was 65,000 h⁻¹. A flow rate of methane (i.e., flow rate of hydrocarbon) to be supplied to the reforming unit 5 was 0.35 NL/min. An operating temperature of the reforming unit was 650° C. As a reforming catalyst, a mixture containing Pt and Ni was used.

After execution of the normal operation for 350 hours, the carbon removal step was executed. Specifically, air was supplied to the reforming unit 5 for five minutes at a flow rate (1.4 NL/min) four times the flow rate of methane during the normal operation. After execution of the carbon removal step, the normal operation was executed again. Before and after the carbon removal step, a concentration of the hydrogen at an outlet of the reforming unit 5 was measured.

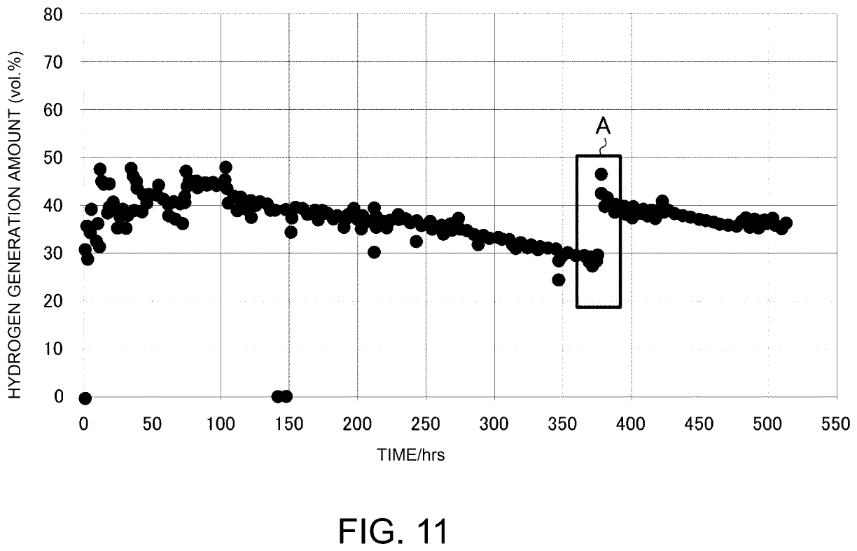

The results are illustrated in FIG. 11. FIG. 11 illustrates a graph of an operation time and a hydrogen generation amount. In FIG. 11, a region A is a timing at which the carbon removal step is executed. As illustrated in FIG. 11, the hydrogen generation amount decreases as the normal operation is executed. In contrast, it is confirmed that by executing the carbon removal step, the hydrogen generation amount is increased, and the reforming performance is restored.

### Experimental Example 2

The experiment was performed in the same manner as in Experimental Example 1 except that the amount of air to be supplied to the reforming unit 5 in the carbon removal step was changed. Specifically, the carbon removal step was executed by supplying the air to the reforming unit 5 at flow rates of one time, three times, four times, and ten times the flow rate of methane during the normal operation. After the carbon removal step, the hydrogen concentration at the outlet of the reforming unit 5 was measured.

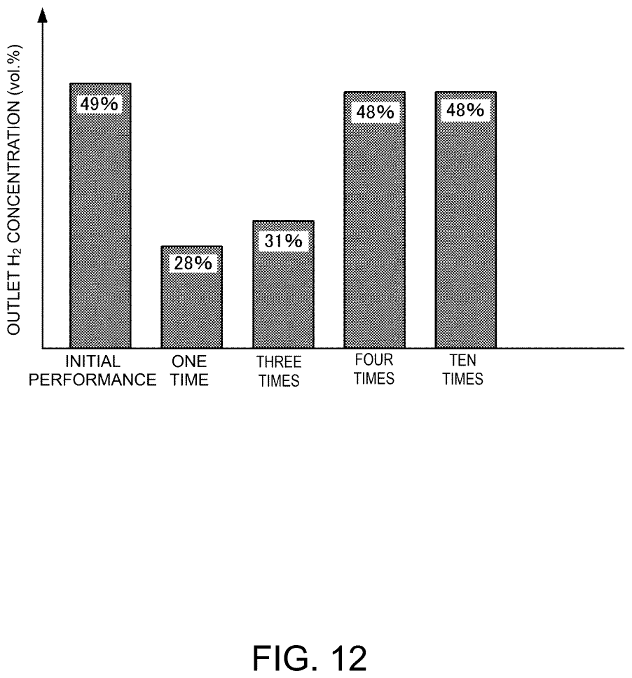

FIG. 12 illustrates results together with an initial performance. As illustrated in FIG. 12, when the air is supplied at a flow rate of four times the flow rate of methane, the outlet H₂ concentration is significantly increased as compared with the case of a flow rate less than that.

### Experimental Example 3

In Experimental Example 1, the air supply time in the carbon removal step was changed to one minute. Other conditions were the same as those in Experimental Example 1. Further, when the reforming performance is confirmed before and after the carbon removal step, it is confirmed that the reforming performance is restored.

### Experimental Example 4

In Experimental Example 1, the reforming catalyst was changed to a catalyst containing Rh. Other conditions were the same as those in Experimental Example 1. Further, when the reforming performance is confirmed before and after the carbon removal step, it is confirmed that the reforming performance is restored.

1. A method for controlling a fuel cell system,
the fuel cell system including
a reforming unit configured to reform a fuel gas containing a hydrocarbon to generate a reformed gas, the reforming unit containing a reforming catalyst, and
a fuel cell stack configured to generate electricity by using the reformed gas as an anode gas,
the control method comprising:
a normal operation step of causing the fuel cell stack to generate electricity while supplying the fuel gas to the reforming unit; and
a carbon removal step of removing carbon deposited on the reforming catalyst, wherein the carbon removal step includes a step of supplying air to the reforming unit, and
a flow rate of the air to be supplied to the reforming unit in the carbon removal step is larger than a flow rate of the hydrocarbon to be supplied to the reforming unit in the normal operation step.

2. The control method according to claim 1, wherein
the flow rate of the air to be supplied to the reforming unit in the carbon removal step is four times or more the flow rate of the hydrocarbon to be supplied to the reforming unit in the normal operation step.

3. The control method according to claim 1, wherein
the fuel gas contains methane.

4. The control method according to claim 1, further comprising:
a step of determining whether to execute the carbon removal step based on an execution time of the normal operation step.

5. The control method according to claim 1, further comprising:
a step of determining whether to execute the carbon removal step based on an outlet temperature of the reforming unit.

6. The control method according to claim 1, further comprising:
an activation step of activating the fuel cell stack before the normal operation step, wherein
the carbon removal step is executed in the activation step.

7. The control method according to claim 6, wherein
the fuel cell system further includes
an air supply line configured to supply the air to a cathode of the fuel cell stack, and
a combustor thermally connected to the air supply line and configured to heat the air,
the activation step includes a combustor activation step of activating the combustor to a predetermined temperature or higher,
the carbon removal step is executed after the combustor activation step, and
the carbon removal step includes a step of sending the removed carbon to the combustor.

8. The control method according to claim 7, wherein
the fuel cell stack includes
a first stack, and
a second stack,
the reforming unit is disposed on an anode of the first stack,
the air supply line is connected to a cathode of the second stack,
the first stack and the second stack are connected to each other such that a gas flows from the anode of the first stack to an anode of the second stack and a gas flows from the cathode of the second stack to a cathode of the first stack,
the activation step includes a warm-up step of heating the fuel cell stack by supplying the air to the cathode of the second stack via the air supply line after the combustor activation step, and
the carbon removal step is executed during the warm-up step.

9. The control method according to claim 1, wherein
the carbon removal step includes a step of stopping the supply of the air to the reforming unit when a temperature of the reforming unit reaches a first temperature.

10. The control method according to claim 1, wherein
the carbon removal step includes a step of supplying the air from an air supply unit to the reforming unit without heating.

11. The control method according to claim 1, wherein
the carbon removal step includes a step of intermittently supplying the air to the reforming unit.

12. The control method according to claim 1, wherein
the carbon removal step includes a step of supplying the air to the reforming unit such that the flow rate of the air increases stepwise.

13. The control method according to claim 1, wherein
the reforming unit is disposed in the fuel cell stack.

14. A fuel cell system, comprising:
a reforming unit configured to reform a fuel gas containing a hydrocarbon to generate a reformed gas, the reforming unit containing a reforming catalyst;
a fuel cell stack configured to generate electricity by using the reformed gas as an anode gas; and
a control device, wherein
the control device executes a normal operation step and a carbon removal step,
in the normal operation step, the control device causes the fuel cell stack to generate electricity while supplying the fuel gas to the reforming unit,
in the carbon removal step, the control device supplies air to the reforming unit, and
a flow rate of the air to be supplied to the reforming unit in the carbon removal step is larger than a flow rate of the hydrocarbon to be supplied to the reforming unit in the normal operation step.
